(19) United States
(12) Patent Application Publication
(10) Pub. No.: US 2004/0247030 A1
(43) Pub. Date: Dec. 9, 2004

(54) Method for transcoding an MPEG-2 video stream to a new bitrate

(76) Inventor: Andre Wiethoff, Dortmund (DE)

Correspondence Address: SCHNECK & SCHNECK, P.O. BOX 2-E, SAN JOSE, CA, 95109-0005, US

(21) Appl. No.: 10/458,020

(22) Filed: Jun. 9, 2003

(51) Int. Cl. H04N 7/12

(52) U.S. Cl. 375/240.16; 375/240.03; 375/240.2; 375/240.24; 375/240.12

(57) ABSTRACT

A method for transcoding an MPEG-2 video stream to a new bitrate using the motion vectors from the original stream. A desired bitrate is chosen and the macroblocks of the target frames are requantized accordingly in the transcoder. In order to adjust the motion compensation in the target frames, the difference between the original and target reference frames is added on a pixel-by-pixel basis to the target frame's prediction error, or correction matrix. An ideal quantization value is determined using a perceptive algorithm that reduces image quality in high-activity areas where the human visual system does not perceive quality reduction and enhances image quality in areas where noise is noticeable. The new correction matrix is transformed to a frequency domain by a DCT. A coefficient threshold algorithm then identifies those coefficients that would be set to zero using the ideal quantization value and sets them to zero. The number of zeroed coefficients for each macroblock are counted and a formula (in one embodiment, a lookup table) used to determine a new, lower quantization value. The macroblock is then quantized using this lower quantization value.

### TECHNICAL FIELD

This invention is concerned with transcoding an MPEG-2 video stream, particularly transcoding using motion vectors in the original video stream.

### BACKGROUND OF THE INVENTION

MPEG-2 is commonly used to compress video for broadcast video quality applications such as digital television set-top boxes and DVD. Video is compressed using the MPEG-2 standard by taking advantage of spatial and temporal redundancies in the original video as well as the fact that the human eye is less sensitive to detail in areas around object edges or shot changes. By removing as much of the redundant information from video frames as possible and introducing controlled impairments to the video, which are not visible to a human observer, large compression rates may be achieved.

Spatial redundancies, which may be thought of as similarities within a frame, may be removed by performing a two-dimensional discrete cosine transform (“DCT”) on blocks of 8×8 pixels of video frames. The DCT, which is well-known in the art, produces blocks of DCT coefficients, each of which indicates a combination of horizontal and vertical frequencies present in the original block. The DCT generally concentrates energy into low-frequency coefficients while many other coefficients are near zero. Bit rate reduction is achieved by not transmitting the near-zero coefficients and quantizing the remaining coefficients. Quantizing (also well-known in the art) reduces the number of bits required to represent each coefficient; many coefficients are effectively quantized to zero. This increases compression.

Temporal redundancies, which may be thought of as similarities between frames, are removed by predicting a frame from a reference frame. Motion vectors representing horizontal and vertical displacement between the macroblock being encoded and the reference frame are calculated by a motion estimator in an encoder. The motion estimator then sends the matching reference block to a subtractor, which subtracts the reference block on a pixel-by-pixel basis from the macroblock being encoded. This process forms a prediction error between the reference frame and the frame being encoded. Macroblocks having motion compensation consist of motion vectors and the prediction error. Once temporal redundancies have been removed, spatial redundancies are removed as described above.

An MPEG-2 stream is composed of I-frames (intra frames), P-frames (predictive frames), and B-frames (bi-directional frames). I-frames contain all the spatial information of a video frame and are the only frames that are coded without reference to other frames. Some compression may be achieved by reducing spatial redundancy; temporal redundancy cannot be reduced in an I-frame. P-frames use the previous reference frame (an I- or P-frame) for motion compensation. P-frames reduce both spatial and temporal redundancy and therefore achieve greater compression than I-frames. B-frames can use the previous and/or next reference frames for motion compensation and offer more compression than P-frames.

A summary of MPEG coding/decoding is provided in FIGS. 1a and 1b. In FIG. 1a, input video 10 is fed to the encoder 22. The motion estimator 12 calculates motion vectors as described above. The subtractor 18 subtracts the reference frame (sent by the motion compensator 14) from the current macroblock to form the prediction error which is then transformed from the spatial domain by DCT 20, quantized 24, and losslessly encoded 32, which further reduces the average number of bits per DCT coefficient. (No motion estimation or motion compensation occurs for I-frames; instead, the quantized DCT coefficients represent transformed pixel values rather than a prediction error.) The quantized prediction error for P-frames (or, for I-frames, the quantized frequency components) is then inverse quantized 26, and returned to the spatial domain 28 by an inverse discrete cosine transform (IDCT) in order to provide a reference frame 30, 16 for the next frame entering the encoder 22. The encoded DCT coefficients are combined with the motion vectors and sent to the decoder 40, shown in FIG. 1b.

Referring to FIG. 1b, at the decoder 40 the DCT coefficients are decoded 34 and the motion vectors sent to the motion compensator 48. The decoded DCT coefficients corresponding to the prediction error are transformed to the spatial domain via inverse quantization 36 and IDCT 38. I-frames have no motion vectors and no reference picture, so the motion compensation is forced to zero. P- and B-frames' macroblocks' motion vectors are translated to a memory address by the motion compensator 48 and the reference frame is read out of memory 46. The reference frame is added 42 to the prediction error to form the output 44. Reference frames are stored 46 for use decoding other frames.

In FIG. 2, the MPEG-2 video bitstream structure is shown to consist of several layers. The sequence layer 50 contains a number of pictures, or frames. The picture layer 52 contains a number of slices, while the slice layer 54 contains a number of macroblocks. The macroblock layer 56 contains information including a quantization value 58 and motion vectors 60. The block layer 62 contains the quantized DCT coefficients of the prediction error.

MPEG-2 video streams may be transcoded, i.e., converted from one compressed format to another. As shown in FIG. 3, an original video stream 64 is sent to a transcoder (generally, software) 66, which produces the target, or output, stream 68. Possible applications of transcoding include duplicating a DVD, converting a compressed video to another bit rate, changing coding parameters, and changing coding standards. Transcoding can be quite time-consuming if new motion vectors are required. Therefore, it is desirable to use the original motion vectors (which are present in the input video stream as shown in FIG. 2). However, the quality of video may be noticeably degraded if the same motion compensation vectors are used with a reference frame that has been altered during the transcoding process since the prediction error will no longer be accurate. This is known as “drift.”

There is a need for a method for transcoding an MPEG-2 video stream using the original motion vectors that does not noticeably degrade video quality.

### SUMMARY OF THE INVENTION

This need has been met by a method for transcoding an MPEG-2 stream to a new bitrate that modifies an encoded video stream without having to decode and re-encode the entire video stream. A desired bitrate is chosen and the macroblocks of the original frames are requantized accordingly in the transcoder to form macroblocks of target frames. The original and target reference frames have to be completely decompressed during transcoding in order to adjust the motion compensation correctly since the original motion vectors refer to target reference frames that differ from the original reference frames. The difference between the original and target reference frames is added on a pixel-by-pixel basis to the prediction error, or correction matrix.

An ideal quantization value is determined using a perceptive algorithm that reduces image quality in high-activity areas where the human visual system does not perceive quality reduction. The new correction matrix (or, in the case of I-frames, the matrix containing pixel values) is transformed to a frequency domain by a DCT. A coefficient threshold algorithm then identifies those coefficients that would be set to zero or near zero using the ideal quantization value and sets them to zero. The number of zeroed coefficients for each macroblock are counted and a formula (in one embodiment, a lookup table) used to determine a new, lower quantization value. The macroblock is then quantized using this lower quantization value. Decreasing the quantization factor results in the remaining non-zero, usually low frequency coefficients being represented more precisely; therefore, the resulting image quality is high without increasing the bitrate.

### BRIEF DESCRIPTION OF THE DRAWINGS

FIG. 1a is a block diagram of an MPEG encoder.

FIG. 1b is a block diagram of an MPEG decoder.

FIG. 2 is a block diagram of an MPEG-2 video bitstream structure.

FIG. 3 is a block diagram of a transcoder.

FIG. 4 is a flowchart showing the transcoding process of the present invention.

FIG. 5 is another block diagram of a transcoder in accordance with the invention.

FIG. 6 is a graph showing the reduction of quantization steps by removing coefficients in accordance with the invention.

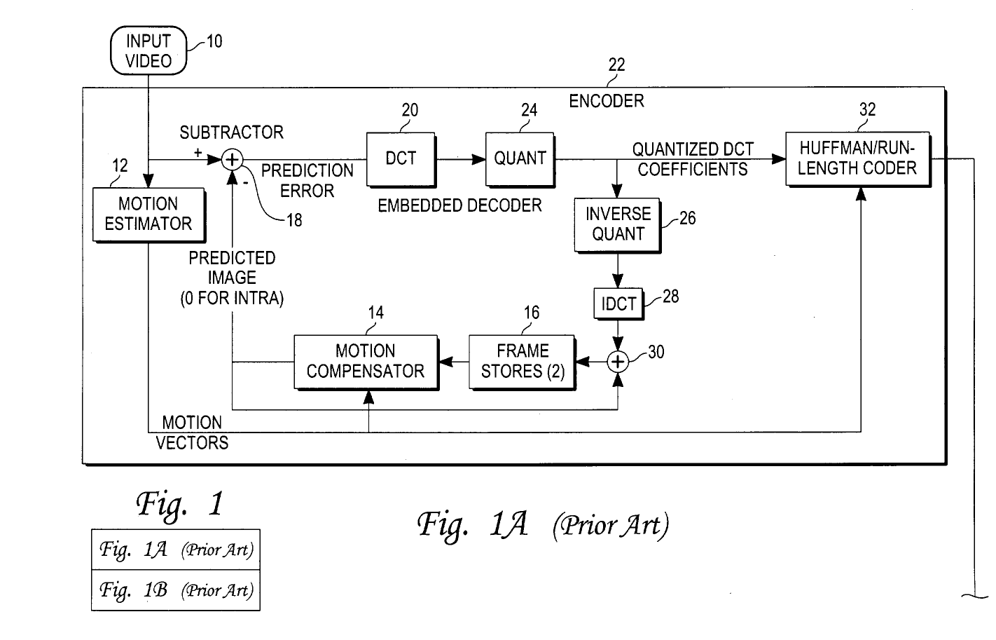

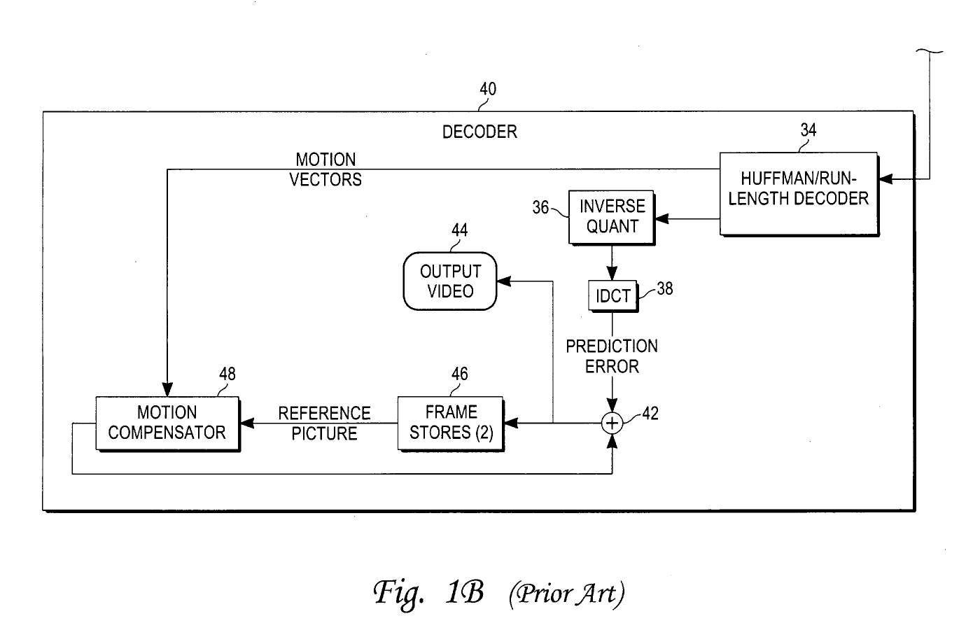

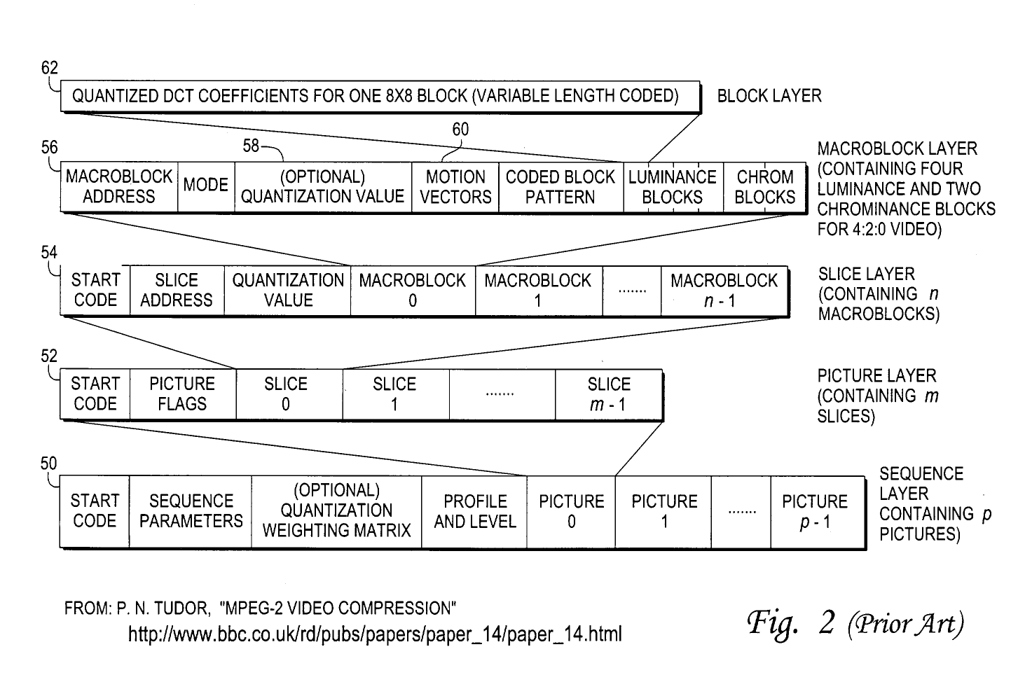

### DETAILED DESCRIPTION

The method of the present invention may be implemented by software stored on some computer-readable medium and running on a computer.

Before beginning the transcoding process, an estimated target bitrate is determined. Varying the quantization step applied to the video stream will affect the size of the output and therefore the bitrate as well. In order to determine the base quantization value necessary to achieve the desired bitrate, an excerpt of the video (around 100 GOPs (Group of Pictures)) is compressed with three to five different base quantization factors. The formula for the target size/original size ratio of the videos, which depends on the base quantization value is given by:

video_size(quant)=x0*quant^{x1}+x2

where quant=base quantization value x0, x1, and x2 are parameters defining the curve for a special stream. The values x0, x1, and x2 can be determined by doing three passes on encoding the video excerpt and solving an equation system, as the resulting size of each pass and the original size is known. These three passes (in some embodiments, five passes) are always done with different quantization values. In one embodiment employing three passes, the quantization values 2, 5, and 15 are used.

As noted above, x0, x1, and x2 can be determined by approximating schemes. If q=base quantization value and s=video_size(quant), and these values are given (for instance, by the 3 quantization values), then:

s1=x0*q1^{x1}+x2

s2=x0*q2^{x1}+x2

s3=x0*q3^{x1}+x2

The values of x0, x1, and x2 can be determined as follows:

x2=s3−x0*q3^{x1} (so, when x0 and x1 are known, x2 is also known)

x0=(s2−s3)/(q2^{x1}−q3^{x1}) (so, if x1 is known, x0 is also known)

(q3^{x1}−q1^{x1})/(q2^{x1}−q3^{x1})*(s2−s3)−(s1−s3)=0

This equation can be easily approximated by an algorithm. Once x1 is known, x0 and x2 are also known.

Once the three variables are determined, the formula given above for determining video_size(quant) may be used to determine the target video size when a base quantization value is used. Using the inverse function, a base quantization value may be determined given a target video size. This algorithm is fully correct only for pure constant quality (CQ) models (which, by definition, are always variable bitrate (VBR)).

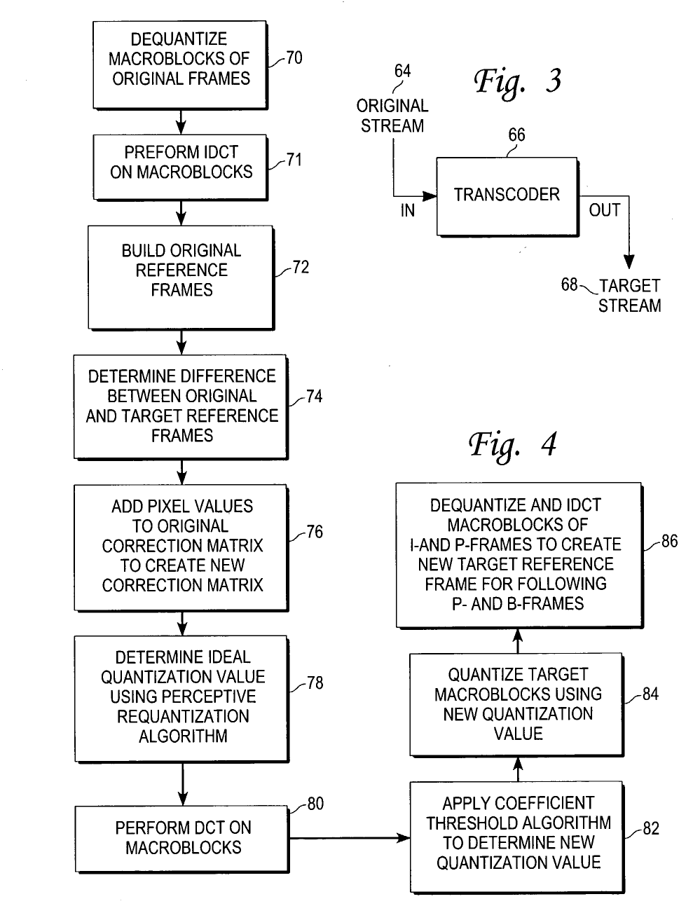

When the original encoded MPEG-2 video stream is sent to the transcoder as input, the macroblocks of the original stream frames are requantized, using a new quantization value, discussed in detail in FIG. 4, below, to form macroblocks of the target frames; P-frames are requantized using a slightly higher quantization value while B-frames are requantized with an even higher quantization value (quant values=+0/+1/+3 for I-/P-/B-frames). (Operations are performed on macroblocks to conserve memory.) When the quantization of the frames is altered, all the reference frames are affected since a different quantization matrix is now being used. Since the target stream is using the motion vectors from the original stream, these motion vectors refer to target reference frames that are different from the original reference frames. Therefore, the motion compensation in the target frames has to be adjusted.

Referring to FIG. 4, when the original encoded stream is sent to the transcoder, the original and target reference frames have to be decompressed in order to original frames are dequantized (block 70) and an IDCT is performed on the macroblocks (block 71). The original reference frame is created (motion compensation is used for P-frames; no motion compensation is used to create I-frames) (block 72). (As will be discussed in greater detail below, the matching target reference frame is created at block 86). Each macroblock that uses motion compensation uses both the original and target reference frames. Therefore, up to four reference frames may be accessed at any given time. The difference between the original and target reference frames is determined (block 74) and that difference has to be added to the original correction matrix, or prediction error. (As noted above, an IDCT was performed on the original correction matrix at block 71.) The difference between the frames is added on a pixel-by-pixel basis to the target correction matrix, thus creating a new correction matrix (block 76).

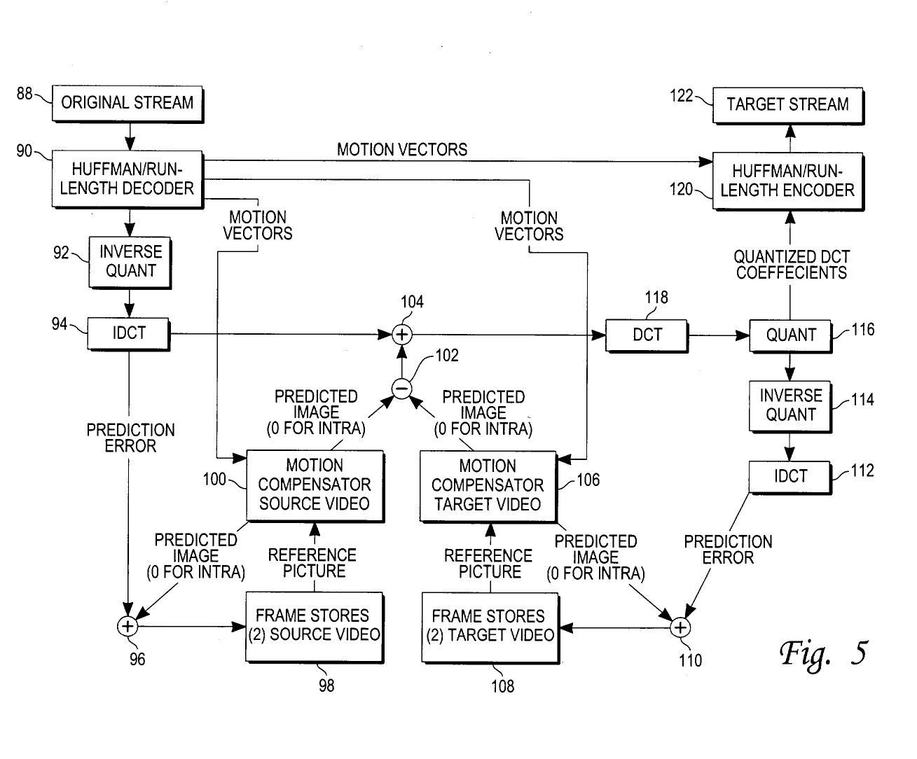

With respect to FIG. 5, when the original stream 88 reaches the transcoder, the DCT coefficients are initially decoded 90 and the motion vectors sent to the encoder 120 and the motion compensators 106, 100 for the original and target streams. The decoded DCT coefficients are transformed to the spatial domain via inverse quantization 92 and IDCT 94 to produce the prediction error, which is added 96, 110 to the predicted image to produce the reference frame 98, 108 for the original and target frames; intra macroblocks have no motion compensation and need no reference frame, so the prediction error is forced to zero. The difference between the original and target frames is determined 102 and the values are added to original correction matrix 104 to produce the new correction matrix 104. (I-frames are also encoded using this same circuit, though no prediction error is used.) A DCT 118 is performed on the macroblock representing either the new correction matrix or intra macroblocks. The macroblock is then quantized 116 and the quantized DCT coefficients are encoded 120 to produce the target stream 122. The I- and P-frames are dequantized 114 and an IDCT 112 is performed to create either a prediction error (for non-intra macroblocks) or image pixels for intra macroblocks in order to create a new reference frame that will be stored in the frame store 108.

Referring again to FIG. 4, the ideal quantization value for each macroblock is determined using a perceptive algorithm (block 78). (D. Farin, “Szenadaptive, Parallele Codierung von Hochaufgelösten Videosequenzen Unter Berücksichtigung der Wahrnehmungsphysiologie,” Diploma thesis, University of Stuttgart (1997); D. Farin et al., “A Software-Based High-Quality MPEG-2 Encoder Employing Scene Change Detection and Adaptive Quantization,” ICCE (2001)) This algorithm reduces the amount of quantization noise in areas where it is most visible to the human visual system (HVS). The HVS is not very sensitive to noise at the ends of the luminance range or in areas with high-frequency texture. The algorithm takes advantage of this property of the HVS by reducing bits in areas where noise is less noticeable and adding bits in other areas where noise would be noticeable. MPEG artifacts are most visible in blocks having both an area with fine, high-contrast texture and an area with low activity. When high-frequency coefficients of the fine, high-contrast texture area are quantized, a ringing effect, typical in MPEG, occurs in the low activity area adjacent to the textured area. To reduce the ringing, more bits are needed to code the blocks containing both textured and flat areas.

Given an image f(x,y), each macroblock is partitioned into 4×4 sub-blocks consisting of 4×4 pixels. The sub-block activity subact for each of these sub-blocks is calculated as:

$${subact}_{kx , ky} := ln [ {\sum }_{x = 0}^{2} {\sum }_{y = 0}^{3} \vert {f}_{kx , ky} ( x + 1 , y ) - {f}_{kx , ky} ( x , y ) \vert + {\sum }_{x = 0}^{3} {\sum }_{y = 0}^{2} \vert {f}_{kx , ky} ( x , y + 1 ) - {f}_{kx , ky} ( x , y ) \vert ]$$

The overall “busyness” (bsy) of the macroblock can be calculated as the sum of all sub-block activities in the macroblock:

$$busyness ( subact ) := \frac{{\sum }_{x = 0}^{3} {\sum }_{y = 0}^{3} {subact}_{x , y}}{16}$$

High-frequency texture is indicated by larger values of busyness (bsy).

A measure of risk of ringing (rng) can be calculated by summing absolute differences of neighboring sub-block activities in 8×8 pixel blocks in the macroblock:

$$\begin{matrix}ringing ( subact ) := {\sum }_{x = 0}^{2} {\sum }_{y = 0}^{3} \vert {subact}_{x + 1 , y} - {subact}_{x , y} \vert + \\ {\sum }_{x = 0}^{3} {\sum }_{y = 0}^{2} \vert {subact}_{x , y + 1} - {subact}_{x , y} \vert\end{matrix}$$

Corrections for smooth areas and luminance masking may also be made. Smoothness is defined by low derivations of the macroblock's luminance in x and y directions, i.e., two (either vertically or horizontally) adjacent pixels, p1 and p2, have little difference in luminance (e.g., in the formula p1−p2<α for all adjacent pixels in the macroblock, if pixel luminance values are between 0 and 255, a low value of a would probably be between 2 and 5, indicating that luminance is increasing slowly, giving the overall impression that the image is smooth). In order to calculate this factor, the smallest sub-block activity (smallest(subact)) for busyness or ringing is used as a parameter.

smallest(subact)=min(busyness(subact),ringing(subact))

The smoothness factor (smoothness(subact)) is calculated as follows:

$$smoothness ( subact ) := \{ \begin{matrix}1.0 for smallest ( subact ) > λ \\ 2.0 for smallest ( subact ) < μ \\ 2.0 - log ( ψ \frac{smallest ( subact ) - μ}{μ} + 1.0 ) otherwise\end{matrix}$$

In this formula, λ>μ. λ, ψ, and μ are empirically determined constant values. The smoothness factor will always be between 1 and 2.

Luminance masking is also performed. As noted above, the human eye is not very sensitive to noise at extremes of its dynamic range; therefore, noise may be introduced at these extremes without negatively impacting image quality. In order to perform luminance masking, average luminance (avglum) of a macroblock must be calculated by taking all the pixels' luminance, adding them up, and dividing by the number of pixels. Avglum=0 . . . 255, (i.e., avglum can only have a value between 0 and 255). Luminance masking (luminancemask(avglum)) is calculated as follows:

luminancemask(avglum):=θ·e^{κ·avglum}+δ·e^{ξ·(avglum-256)}

The values for δ, θ, κ, and ξ are all empirically determined constant values.

A perceptive quantization factor addquant is determined as follows:

$$addquant ( subact , quant ) := log ( \frac{quant}{ρ} ) \cdot [ α \cdot {busyness ( subact )}^{γ} + β \cdot {ringing ( subact )}^{ϵ} - ω \cdot {( smoothness ( subact ) - 1 )}^{p} ] + luminancemask ( avglum )$$

“Quant” is the base quantization factor. The quantization value will increase when there is no smoothness factor. The values ρ, α, β, ε, γ, ω, and ν are all empirically determined constant values. (In one embodiment, ω and ν are 1.) These constant values (as well as other empirically determined constant values in other equations discussed above) have a limited range given the formulas in which they are employed. In other words, if one of the constants deviates too far from its natural range, bad values will result. The constants are initially set to their “natural” value (usually, 1.0, −1.0, or 0.0 based upon the expected result for that equation. Normally, a multiplicative constant, such as α, β, and ω, above, would be set to 1. Constants used as exponents, such as γ, ε, and ν, above, would be set to 1 or −1 depending on whether the function being raised to a power should progress or regress. Additive constants are normally initially set to 0.). The constants are then modified until the result does not improve when compared to the expected result (an image that appears to be of similar quality as the original image). In most cases, a debug build of the transcoder saves images to be analyzed as well as values of selected test images to files on the hard disk. Images are analyzed with a picture viewer while the values are analyzed with a math analyzing tool; the images and the values are compared with the original pictures to determine where and how to change the parameters. The images to be analyzed usually depict one function, for instance busyness, showing one single greyscale color for each macroblock. This approach allows the user to manually view/control whether the chosen constants worked and produced the expected results.

For each of the equations discussed above, the calculations may be floating- or fixed-point, though fixed-point calculations are used here. Integers should not be used because the values are too coarse for quantization value calculations.

Referring again to FIG. 4, a DCT is performed on the new correction matrix to transform it to a frequency domain (block 80). A coefficient threshold algorithm, which is known in the art, is then applied to determine a better quantization value (block 82). This algorithm identifies those coefficients that would be set to zero by the ideal quantization value upon quantization and sets those coefficients as well as those values that would be “near zero” (as determined by tests) directly to zero. The number of zeroed coefficients is counted and, using a formula or, in one embodiment, a lookup table, a lower quantization value is determined.

The transcoder uses the original quantization matrix, embedded in the original stream, to dequantize macroblock matrices. To create the target stream, the transcoder uses a quantization matrix (to be stored in the target stream) optimized for a low bitrate to quantize the final DCT coefficients. (The creation of such a quantization matrix is well-known in the art). All coefficients used in the thresholder are dequantized and in the frequency domain. Coefficient thresholding works differently for intra and non-intra DCT coefficients. In both cases, the thresholder will take the base quantization value (or, in another embodiment, it may take the ideal quantization value calculated up to that point instead) and multiply it with a constant factor. Every non-zero coefficient is divided by its appropriate value from the optimized quantization matrix. If the divided coefficient is smaller than the modified base value, the coefficient is zeroed and a counter is increased. However, for intra macroblocks, the first six coefficients (in zig-zag order) are never zeroed out and never counted. These operations are performed on all matrices of a macroblock (in DVD, each macroblock usually has 4 blocks for luminance and 2 blocks for chrominance). After these operations are performed, an average of the number of zeroed coefficients is calculated; this average is used in the table for decreasing the current calculated quantization value by a given percent. The table value is multiplied by the calculated smoothness factor, which, as noted above, is always between 1 and 2.

For example, suppose Q is the quantization matrix, D is the coefficient matrix, b is the base quantization value (or it could also be the current quantization value in another embodiment), and c, a counter, is initially set to zero. When processing D_{7,3}, the thresholder determines whether the coefficient is already zero. If so, no further action is taken. Otherwise, the thresholder determines whether D_{7,3}/Q_{7,3}<α*b, where α is an empirically-determined constant. If so, then D_{7,3} is set to zero and c is increased. After all matrices of the macroblock are processed in this manner, c is divided by the number of processed matrices. The averaged value of c is then looked up in the table and the ideal quantization value is multiplied by the number given in the table and the previously-calculated smoothness factor. The formula to determine the final quantization value (final quantvalue) is as follows:

finalquantvalue=idealquantvalue-percent/100*smoothness*idealquantvalue

A lookup table used in one embodiment is shown below other values may be used in other embodiments). The values specify the percentage of the reduction of the quantization value for the number of zeroes introduced by the coefficient threshold algorithm. The table has 64 entries as this is the maximum number of coefficients.

| Introduced | |
|---|---|
| zeroes | Percentage |
| 1 | 0 |
| 2 | 0 |
| 3 | 1 |
| 4 | 1 |
| 5 | 2 |
| 6 | 2 |
| 7 | 3 |
| 8 | 3 |
| 9 | 4 |
| 10 | 4 |
| 11 | 5 |
| 12 | 5 |
| 13 | 6 |
| 14 | 7 |
| 15 | 9 |
| 16 | 10 |
| 17 | 11 |
| 18 | 12 |
| 19 | 14 |
| 20 | 15 |
| 21 | 17 |
| 22 | 18 |
| 23 | 19 |
| 24 | 21 |
| 25 | 23 |
| 26 | 24 |
| 27 | 25 |
| 28 | 27 |
| 29 | 30 |
| 30 | 32 |
| 31 | 35 |
| 32 | 37 |
| 33 | 40 |
| 34 | 43 |
| 35 | 46 |
| 36 | 49 |
| 37 | 53 |
| 38 | 57 |
| 39 | 60 |
| 40 | 63 |
| 41 | 66 |
| 42 | 70 |
| 43 | 73 |
| 44 | 75 |
| 45 | 78 |
| 46 | 80 |
| 47 | 82 |
| 48 | 85 |
| 49 | 87 |
| 50 | 90 |
| 51 | 92 |
| 52 | 94 |
| 53 | 95 |
| 54 | 96 |
| 55 | 96 |
| 56 | 97 |
| 57 | 97 |
| 58 | 98 |
| 59 | 98 |
| 60 | 99 |
| 61 | 99 |
| 62 | 100 |
| 63 | 100 |
| 64 | 100 |

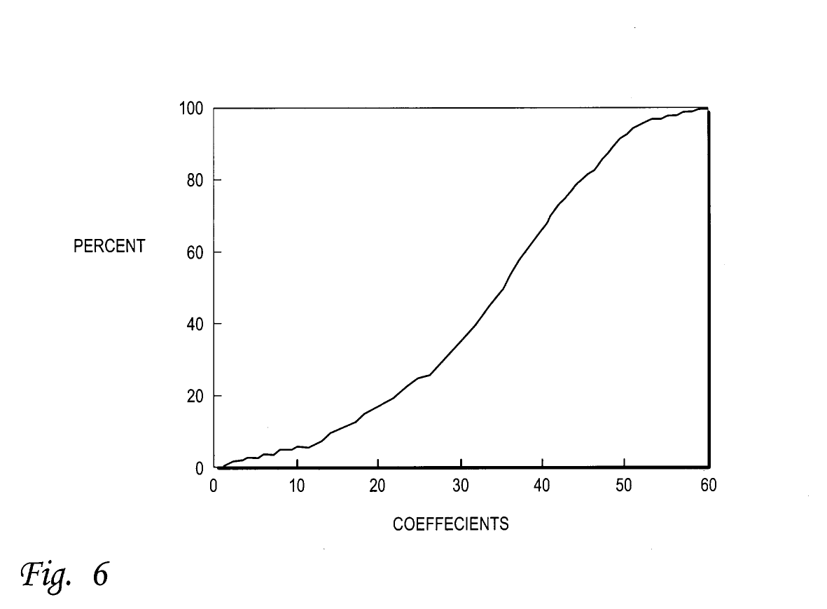

Reducing quantization steps means that the remaining non-zero, usually low frequency, coefficients can now be represented more precisely and therefore improve image quality. FIG. 6 shows how this process improves (lowers) the number of quantization steps (expressed as a percentage) when a given number of coefficients are left out without increasing the bitrate.

Referring again to FIG. 4, the macroblock is then quantized using the new quantization value (block 84). The macroblocks of I- and P-frames are then dequantized and an IDCT performed on them to create new target reference frames for the following P- and B-frames (block 86).

The method outlined above may be used to copy DVDs quickly (faster than real-time copying since the entire video stream does not need to be entirely decoded and reencoded) without a noticeable loss of quality.

1. A method for transcoding an MPEG-2 video stream to a new bitrate using motion vectors in the original stream comprising:
a) correcting motion compensation in each target macroblock having motion compensation;
b) determining an ideal quantization value for each target macroblock by using a perceptive algorithm;
c) applying a discrete cosine transform algorithm to each target macroblock;
d) performing a coefficient threshold algorithm on each target macroblock to determine how many quantization steps can be reduced, thereby setting a new quantization factor; and
e) quantizing each target macroblock using the new quantization factor.

2. The method of claim 1 further comprising determining a desired bitrate for the target stream.

3. The method of claim 1 further comprising dequantizing and performing an inverse discrete cosine transform algorithm on the macroblocks of original stream reference frames.

4. The method of claim 1 wherein correcting the motion compensation in the target macroblock having motion compensation is accomplished by determining a difference between the original and target reference frames.

5. The method of claim 4 further comprising adding the difference between the original and target reference frames to an original correction matrix of the target macroblock having motion compensation to create a new correction matrix.

6. The method of claim 5 wherein adding the difference between the original and target reference frames to the original correction matrix is accomplished by performing an inverse discrete cosine transform algorithm on the original correction matrix and adding pixel values based on the difference between original and target reference frames to the original correction matrix to produce the new correction matrix.

7. The method of claim 1 further comprising dequantizing and performing an inverse discrete cosine transform algorithm on the macroblocks of target reference frames to create a new target reference frame for following P- and B-frames.

8. A method for transcoding an MPEG-2 video stream to a new bitrate using motion vectors in the original video stream comprising:
a) receiving an encoded MPEG-2 video stream at a transcoder;
b) dequantizing and performing an inverse discrete cosine transform algorithm on the macroblocks of original stream reference frames;
c) creating a new prediction error for each target macroblock having motion compensation based on a determined difference between the original and target video reference frames;
d) determining an ideal quantization value for each target macroblock by using a perceptive algorithm;
e) applying a discrete cosine transform algorithm to each target macroblock;
f) performing a coefficient threshold algorithm on each target macroblock to determine how many quantization steps can be reduced, thereby setting a new quantization factor;
g) quantizing each target macroblock using the new quantization factor; and
h) dequantizing and performing an inverse discrete cosine transform on the macroblocks of target reference frames to create a new target reference frame for following P- and B-frames.

9. The method of claim 8 wherein the new prediction error is created by adding pixel values based on the determined difference between the original and target video reference frames to the target macroblock.

10. A computer-readable storage medium storing instructions that, when executed, cause the computer to perform a method for transcoding an MPEG-2 video stream to a new bitrate using motion vectors in the original stream, the method comprising:
a) correcting motion compensation in each target macroblock having motion compensation;
b) determining an ideal quantization value for each target macroblock by using a perceptive algorithm;
c) applying the discrete cosine transform algorithm to each target macroblock;
d) performing the coefficient threshold algorithm on each target macroblock to determine how many quantization steps can be reduced, thereby setting a new quantization factor; and
e) quantizing each target macroblock using the new quantization factor.

11. The computer-readable storage medium of claim 10, the method further comprising determining a desired bitrate for the target stream.

12. The computer-readable storage medium of claim 10, the method further comprising dequantizing and performing an inverse discrete cosine transform algorithm on the macroblocks of original stream reference frames.

13. The computer-readable storage medium of claim 10, wherein correcting the motion compensation in the target macroblock having motion compensation is accomplished by determining a difference between the original and target reference frames.

14. The computer-readable storage medium of claim 13, the method further comprising adding the difference between the original and target reference frames to an original correction matrix of the target macroblock having motion compensation to create a new correction matrix.

15. The computer-readable storage medium of claim 14, wherein adding the difference between the original and target reference frames to the original correction matrix is accomplished by adding pixel values based on the difference between original and target reference frames to the original correction matrix to produce the new correction matrix.

16. The computer-readable storage medium of claim 10, the method further comprising dequantizing and performing an inverse discrete cosine transform on the macroblocks of target reference frames to create a new reference frame for following P- and B-frames.
